(19) United States
(12) Patent Application Publication
(10) Pub. No.: US 2001/0055495 A1
(43) Pub. Date: Dec. 27, 2001

(54) Method and apparatus for setting register in a multicolor printing machine

(75) Inventors: Ingo Klaus Dreher, Kiel (DE); Patrick Metzler, Gettorf (DE); Karlheinz Walter Peter, Molfsee (DE)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 09/858,621

(22) Filed: May 16, 2001

Related U.S. Application Data
(60) Provisional application No. 60/204,892, filed on May 17, 2000.

(51) Int. Cl. G03G 15/00

(52) U.S. Cl. 399/45; 399/301

(57) ABSTRACT

The invention relates to a method and apparatus for the digital production of color separations (3, 3′, . . . ), the actions of setting up and combining the color separations (3, 3′, . . . ) being controlled when printing substrates (16) of a different grade are fed in, in order to correct the register setting.

These are to be designed in such a way that in the event of a change in the printing substrate, the influence of this change on the register can to a large extent be counteracted before the printing substrate is fed to the printing process.

This is achieved in that when the printing substrate thickness (17) is changed because of a printing-substrate change, the influence of the printing substrate thickness (17) on the register is taken into account directly as the change is implemented, by means of existing influencing variables (4, 4′, . . . ).

The invention relates to a method for setting register in a multicolor printing machine having a number of items of equipment for the digital production of color separations, the actions of setting up and combining the color separations being controlled when printing substrates of a different grade are fed in, in order to correct the register setting.

The invention further relates to apparatus for 15 implementing the method with a multicolor machine having a number of items of equipment for the digital production of color separations, at least one controller performing a register correction by controlling the actions of producing and combining the color separations when printing substrates of a different grade are fed in.

Printing colored illustrations, in particular colored images, is carried out by a number of color separations being printed over one another. These are generally the colors yellow, magenta and cyan as well as black. If required, special colors are added. By means of overprinting these colors, all color combinations can be achieved, the quality of the prints depending significantly on the in-register overprinting of the color separations. In the case of digital printing processes, for example, electrostatic printing processes, the maintenance of the register of the overprint is achieved by the image production devices being controlled in such a way that the color separations meet one another in-register when they are transferred to a printing substrate.

A method and an apparatus of the type mentioned at the beginning are disclosed by U.S. Pat. No. 5,689,757. The teaching of this document is to take account of the influence of the roughness of the paper on the register when printing substrates of a different grade are fed in. For this purpose, the roughness of a paper, which is to be printed, is measured. The influence of the paper roughness on the register is then taken into account by the register controller before the paper is fed to the printing process.

It has been shown that influencing the register accuracy as a result of changing the printing substrate can be detected only inadequately in this way, so that a high print quality cannot be achieved. This leads to the situation where satisfactory register accuracy can be achieved only by means of a correction, which is based on evaluating the printing result. The disadvantage of setting the register by evaluating the printing result, for example, by means of register marks, is, however, that in the event of a change in the printing substrate as a result of a printed-page change, counteractive control is only ever possible for the following print, since the effect of the change in an influencing variable is only detected when it has already caused a register fault. As a result, test prints are necessary and time is wasted, this being uneconomical and therefore unacceptable for small editions or where only one copy is to be printed.

The invention is, therefore, based on the object of designing a method and an apparatus of the type mentioned at the beginning in such a way that in the event of a change in the printing substrate, the influence of this change on the register can, to a large extent, be counteracted before the printing substrate is fed to the printing process.

According to the invention, the object is achieved with respect to the method in that, when the printing substrate thickness is changed because of a printing-substrate change, the influence of the printing substrate thickness on the register is taken into account directly as the change is implemented, by means of existing influencing variables.

According to thei nvention, the object is achieved with respect to the apparatus in that the at least one controller is desired in such a way that when the printing substrate thickness is changed because of a printing-substrate change, the influence of the printing substrate thickness on the register is taken into account directly as the change is implemented, by means of existing influencing variables.

The invention is based on the finding that, in the event of a printing-substrate change, the critical influencing variable, with regard to the register, is the printing substrate thickness. This is because of the movements of the elements carrying the color separations. and substrates are linked to one another by friction. Here, as a result of a change in the printing substrate thickness, the radius which is critical for the transmission ratio between the printing substrate carrier and a cylinder is changed. This changing transmission ratio affects the register to a significantly greater extent than the paper roughness. Primarily, in relation to the influence of the printing substrate thickness, there is no other option than to take it into account in producing and combining the color separations. On the other hand, the influence of the paper roughness can be counteracted in another way as well, in particular by slippage being counteracted by lower transmission of force, the surface condition of the cylinders that carry the color separations and the characteristics of the toner or other materials that influence the transmission of force.

The influence exerted on the register by a printing substrate change is essentially measured by taking the printing substrate thickness into account. By taking into account this influencing variable on the register, before a different grade of printing substrate is fed to the printing process, when setting the register, it is possible for the occurrence of a register fault to be prevented from the outset, so that proofs on printing substrates, for example, with register marks, are generally not needed. It is precisely in the case of small editions or single copies that this is of economic importance, since machine time and often also printing substrates can be saved. In addition, proofs on the printing substrate carriers are possible without feeding printing substrates in order to correct other influences on the register, since the significant influence of the printing substrates is taken into account by detecting their thickness.

As a result of the measure according to the invention, a register setting of known type can be optimized with the effect that, when a printed page is changed and with it a printing substrate is changed, it does not “get out of hand” initially in order to be corrected again later, but rather the register setting remains within the range of tolerable fluctuations, so that with a different grade of printing substrate, it is possible to continue to print without interruption. At the same time, the invention does not exclude additionally taking into account other influencing variables, such as the paper stiffness, the application of toner and also the paper roughness, insofar as these influence the register. In the measure according to the invention, nor does it matter either whether the printing substrate carrier with the printing substrates cooperates directly with the image cylinders in order to transfer the color separations, or whether image transfer cylinders are interposed.

A development of the method provides that in the event of register correction because of a change in printing substrate thickness, the retroactive influence of the 15 printing substrate thickness of the printed page which has gone before but is still in the printing process on the register of the new printed page that is already in the printing process is taken into account. In this case, for each printing unit, account is taken if the transmission ratio is still determined by the printing substrates of the preceding printed page while the setting of an image on the image cylinder with a color separation for the new printed page is already being performed. Furthermore, it is also taken into account that this change in the printing substrate thicknesses takes place successively on one printing unit after the other, that is to say “runs through the machine”. In this way, the maintenance of register of the prints in the event of a change to the printed page is still better ensured. The printing machine can also continue to print without any interruption if, between the setting-up of two color separations, the printed-page change takes place in such a way that the new color separation is already being set up while the preceding color separation of the previous printed page has not yet been transferred, or not completely transferred, to the printing substrate. The maintenance of register is therefore also ensured to a high degree in this overlapping region of two printed pages, and any mutual influence is compensated for. As a result, the economicalness of the printing machine is significantly increased. With regard to the apparatus, this is achieved by the at least one controller being designed in such a way that in the event of a register correction because of a change in the printing substrate thickness, the retroactive influence of the printing substrate thickness of the printed page, which has gone before but is still in the printing process on the register of the new printed page that is already in the printing process, is taken into account.

The influencing variables of the printing substrate thicknesses can be taken into account on the basis of stored data. Detecting a change in the printing substrate thickness as a result of changing the grade of printing substrates can be carried out on the basis of a manual input or by means or measurement of the thickness of the printing substrates before they are fed to the printing process. Here, the influencing variables themselves can be input or it is possible for stored data for the register setting to be activated by means of the input. It is also possible for the printing substrate thicknesses to be taken into account on the basis of a stored file from printed pages. The influencing variables can be stored as stored data, which are allocated to various printing substrate thicknesses or various paper grades.

With regard to the apparatus, provision can be made for it to be equipped with at least one memory, which contains stored values based on experience of influencing variables of various printing substrate thicknesses, the at least one controller controlling the actions of setting up and combining the color separations on the basis of these values based on experience. However, it is also possible to equip the apparatus with an input device, via which the influencing variables of various printing substrate thicknesses to be taken into account can be activated manually. A further alternative is for the device to be equipped with at least one memory, which contains stored values based on experience of influencing variables of various printing substrate thicknesses, the at least one controller controlling the actions of setting up and combining the color separations with the aid of this data.

In addition, the apparatus can have a device for measuring printing substrate thicknesses, and taking the latter into account can be activated by the device. It is also possible for a printing-machine control system and a memory with files from printed pages to be provided, the influencing variables of various printing substrate thicknesses being taken into account on the basis of these files. In this case, it is expedient for the files from the printed pages to be linked with stored data on various printing substrate grades.

In essential terms, the invention pursues the aim of serving to correct a register control system, which is provided. The latter can be designed in such a way that it is based on the detection of register marks, which are printed by the individual printing units. In this case, the invention provides for this correction to be carried out before a change in the printed page and printing substrate can have any influence on the register marks. For the apparatus, provision can also be made for the at least one controller to be designed in such a way that it controls the register by means of register marks which are printed by the individual printing units and detected by a register sensor, and takes the influencing variables of the printing substrate thicknesses as correction factors into account, the correction being effected before a change in the printing substrate and printed page can have any influence on the register.

However, the invention can also be used to correct a register control system, which is based on the detection of the positions of the elements that carry the color separations and substrate. With regard to the apparatus, provision is then made for the at least one controller to be designed in such a way that it controls the register by means of detecting the positions of the elements that carry the color separations and substrate by means of position detecting elements, and takes the influencing variables of the printing substrate thicknesses as correction factors into account. The position detecting elements may, for example, be rotary encoders. Such corrections are made before changes can have any influence on the register marks.

Of course, provision can also be made for further influencing variables which have an influence on the register because of a change to be taken into account when setting the register. These may be, for example, toner profiles, paper grades, the paper stiffness or other influencing variables. With regard to the apparatus, provision must then be made of at least one controller, which is designed to take the further influencing variables into account.

The invention will be explained below with reference to the drawing, in which:

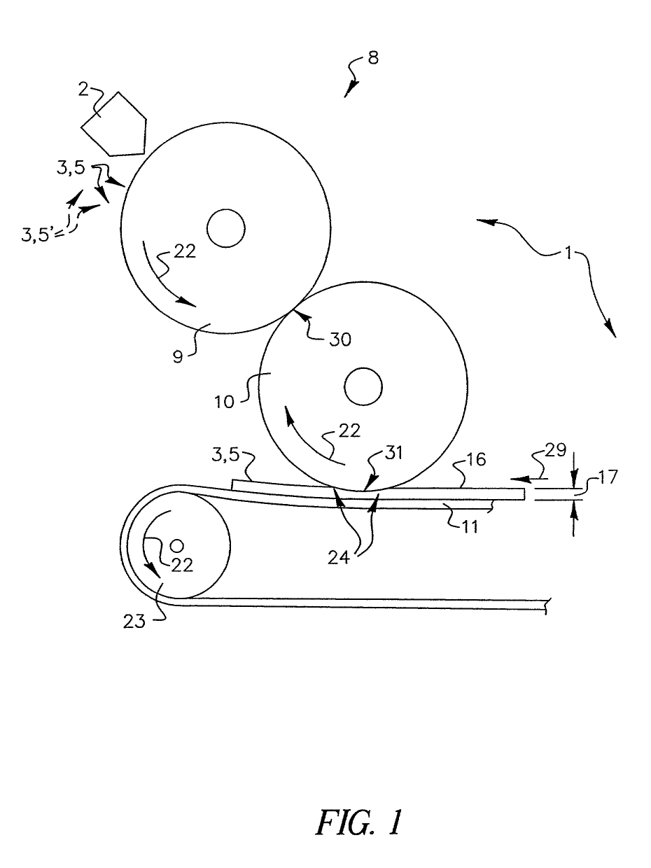

FIG. 1 shows an explanation of the finding on which the invention is based, and

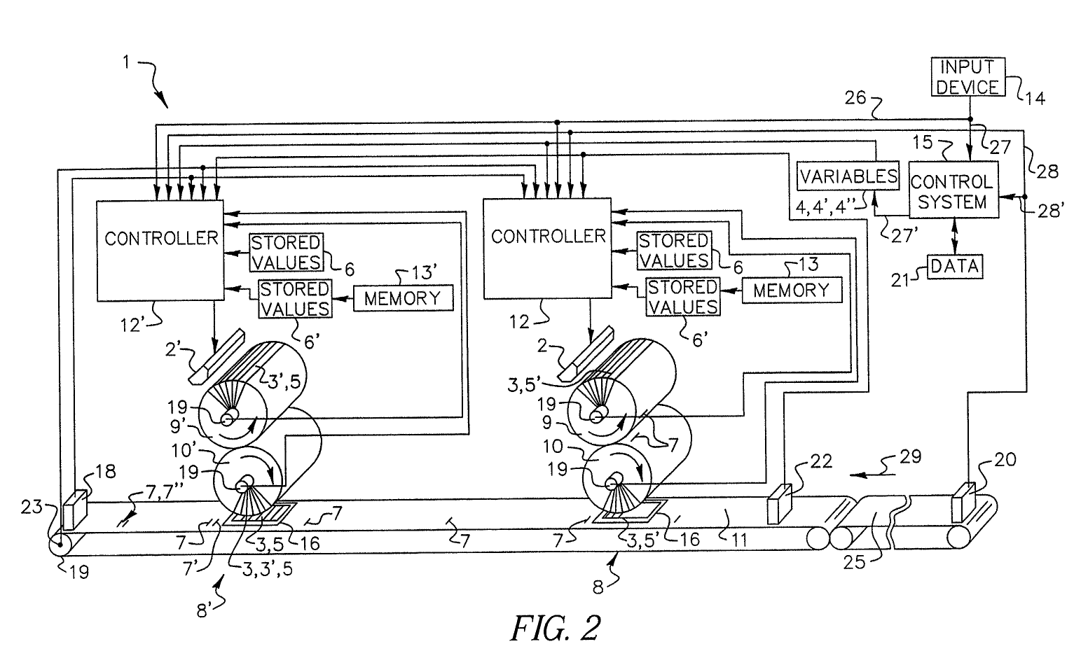

FIG. 2 shows an exemplary embodiment of the invention.

FIG. 1 shows how a change in the printing substrate thickness 17 in the event of a change to the printed pages, 5, 5′ has an influence on the register. The figure shows a printing unit 8 of a multicolor printing machine 1. Multicolor printing machines 1 have a number of printing units 8, 8′, . . . , which have to be imagined as being added here. The printing unit 8 has equipment 2 for the digital production of color separations 3 on an image cylinder 9. The color separation 3 is taken onto an image transfer cylinder 10 by means of a transfer 30 from the image cylinder 9. By means of a further transfer 31, the color separation 3 passes onto a printing substrate 16. The printing substrates 16 are transported by a printing substrate carrier 11, the printing substrates 16 passing through all the printing units 8, 8′, . . . one after another.

In many multicolor printing machines 1 with digital production of color separations 3, 3′ . . . , the drive is provided by a drive roller 23 of the printing substrate carrier 11. In the exemplary embodiment illustrated, the printing substrate carrier 11 in turn drives the image transfer cylinders 10, 10′, . . . , and the latter drive the image cylinders 9, 9′, . . . . Of course, the printing substrate carrier 11 could also drive the image cylinders 9, 9′, . . . directly. This is the case in machines, which do not have any image transfer cylinders 10, 10′, . . . . In this case, the arrows 22 show the directions of rotation of the cylinders 9, 9′, . . . ; 10, 10′, . . . , and the arrow 29 shows the transport direction of the printing substrates 5 and, therefore, the direction of movement of the printing substrate carrier 11.

However, since the printing substrate carrier 11 with the printing substrates 16 is connected by friction to the image transfer cylinders 10, 10′, . . . , and the latter are connected by friction to the image cylinders 9, 9′, . . . , since, for example, the carrier 11 drives the image transfer cylinder 11, a curved attitude 24 is formed at the point of transfer 31, and said attitude influences the speed of the image transfer cylinder 10. If, for example, the paper thickness 17 is changed in the direction of a thicker paper, then the effective radius for driving the image transfer cylinder 10 increases, since the paper thickness 17 is included in said radius. The effective circumference of the image transfer cylinder 10 therefore becomes greater and, as a result, the image transfer cylinder 10 becomes slower in relation to the drive roller 23. However, this problem does not depend on whether the drive is introduced at the drive roller 23 or at another point, since the surfaces of the elements 9, 9′, . . . ; 10, 10′, . . . ; 11 carrying the color separations and substrate roll on one another in any case.

Using FIG. 1, a further problem will also be explained below: while the color separation 3 of the preceding printed page 5 is being transferred from the image transfer cylinder 10 to a printing substrate 16, it is possible that the image cylinder 9 is already being set with the color separation 3 of a new printed page 5′ by the equipment 2. This is shown by the reference symbols 3 and 5′ and the dashed arrows. In this case, in order to maintain the register of the new printed page 5′, the printing substrate thickness 17 of the previous printed page 5 must be included in the calculations for setting the image on the image cylinder 9. For this reason, a development of the invention provides for the at least one controller 12, 12′, . . . ; 15 to be designed in such a way that in the event of a register correction because of a change to the printing substrate thickness 17, the retroactive influence 4 of the printing substrate thickness 17 of the printed page 5 which has gone before but is still in the printing process on the register of the new printed page 5′ this is already in the printing process is taken into account.

FIG. 2 shows an exemplary embodiment of the invention, a multicolor printing machine 1 having two printing units 8, 8′ being illustrated. This is also a simplification; there are normally four or more printing units 8, 8′, . . . . These have to be imagined as being added.

As has already been described, the multicolor printing machine 1 has equipment 2, 2′, . . . for the digital production of color separations 3, 3′, . . . on image cylinders 9, 9′, . . . . Each printing unit 8, 8′, . . . has an image cylinder 9, 9′, . . . and an image transfer cylinder 10, 10′, . . . , the latter transferring the color separations 3, 3′, . . . to the printing substrates 16. The latter are transported through the printing machine 1 in the direction of the arrow 29 by a printing substrate carrier 11.

In order that the color separations 3, 3′, . . . are produced by the equipment 2, 2′, . . . in such a way that they are transferred in-register to the printing substrates 16, controllers 12, 12′, . . . are provided, which control the equipment 2, 2′, . . . in such a way that image starts, lines or areas of the color separations 3, 3′, . . . are coordinated with one another. The controllers 12, 12′, . . . can each be assigned to a printing unit 8, 8′, . . . , or it is possible that their task is taken over by a printing-machine controller 15 for the entire multicolor printing machine 1.

Controllers 12, 12′, . . . ; 15 of this type can be configured in such a way that each printing unit 8, 8′, . . . prints a register mark 7, 7′, . . . , and these register marks 7, 7′, . . . are detected by a register sensor 18. The evaluation of the position of the register marks 7, 7′, . . . then gives the relation of the color separations 3, 3′, . . . , and in the event of deviations a correction can be made in such a way that the color separations 3, 3′, . . . are transferred in-register to the printing substrates 16.

A further possibility consists in the image cylinders 9, 9′, . . . and, if appropriate, also the image transfer cylinders 10, 10′, . . . , being equipped with position detecting elements 19, for example with rotary encoders. A further rotary encoder 19 is provided on the drive roller 23 of the printing substrate carrier 11. By means of these position detecting elements 19, the positions of the cylinders 9, 9′, . . . ; 10, 10′, . . . and of the printing substrate carrier 11 can be set in relation to one another and, as a result, it is possible to detect positional displacements and to correct them by means of the controllers 12, 12′, . . . ; 15, in order that an accurately registered print can be achieved.

Although a change to the register resulting from a change 30 in the printing substrate thicknesses 17 due to a printed-page change can be detected and corrected both by detecting the register marks 7, 7′, . . . and by detecting the position, this has the disadvantage that the effect of the change of the influencing variables 4, 4′, . . . of various printing substrate thicknesses 17 must already have occurred in order to be able to detect and correct it. Using this, however, ongoing continuous printing between a preceding printed page 5 and a new printed page 5′ with a different associated printing substrate thickness 17 is not possible.

The invention, therefore, provides for the at least one controller, 12, 12′, . . . ; 15 to be designed in such a way that, with the aid of existing influencing variables 4, 4′, . . . from printing substrate thicknesses 17, their influence on the register is taken into account directly with a change in the printed page 5, 5′.

One possibility for taking into account influencing 15 variables 4, 4′, . . . of various printing substrate thicknesses 17 is for data on printed pages 5, 5′ to be input at an input device 14 and for this data to be transferred onward from the input device 14 to the controllers 12, 12′, . . . via a connection 26, the controllers 12, 12′, . . . calling up stored values based on experience 6, 6′, . . . for various printing substrate thicknesses 17 from the memories 13, 13′, . . . on the basis of this data on the printed pages 5, 5′, . . . , and as a result obtaining the influencing variables 4 which belong to the same and which are taken into account by the controllers 12, 12′, . . . without any time delay. In this way, the equipment 2, 2′, . . . is capable of performing the digital production of color separations 3, 3′, . . . without interruption and in-register. The stored data 6, 6′, . . . can be stored here as values based on experience for various printing substrate thicknesses 17 in the memories 13, 13′, . . . directly as influencing variables 4, 4′, . . . or for the calculation of the same for the individual printing units 8, 8′, . . . .

With regard to determining the influencing variables 4, 4′, . . . , it is also possible for printed pages 5, 5′, . . . to be provided to the printing-machine controller 15 via the input device 14 and a connection 27, and for said printing-machine controller 15, via a stored file from a memory 21, to call up the influencing variables 4, 4′, . . . to be taken into account—or data for calculating the same—for various printing substrate thicknesses 17. The particular advantage of this embodiment is that virtually everything is carried out via data processing. The influencing variables 4, 4′, . . . , which the printing-machine controller 15 receives from the stored file from the memory 21, are transmitted onward to the controllers 12, 12′, . . . via a connection 27′.

An expedient configuration provides for a device 20 for measuring printing substrate thicknesses 17 to be provided, which measures the thicknesses 17 of the printing substrates 16 fed to the multicolor printing machine 1, for example by a transport belt 25, at least when the printed page 5, 5′ is changed. On the basis of this measurement, the influencing variables 4, 4′, . . . for the measured printing substrate thickness 17 can be called up or the stored data 6, 6′ . . . can be appropriately selected.

In the illustration of FIG. 2, the printing unit 8 is already printing the color separation 3 of the new printed page 5′ while the printing unit 8′ is still printing the color separation 3′ of the preceding printed page 5. In a corresponding way, however, a printed-page change 5, 5′ can also take place at a different time, just within one printing unit 8, 8′, . . . , in such a way as has already been described in relation to FIG. 1. The printing substrate thickness 17 of one printed page 5 must then be taken into account for producing the image of the other printed page 5′.

In order that the controllers 12, 12′, . . . ; 15 can assign the color separations 3, 3′, . . . to the printing substrates 16, a sensor 22 for detecting the position of printing substrates 16 must also be arranged at the start of the printing substrate carrier 11, this sensor informing the controllers 12, 12′, . . . 15 about the position in which a printing substrate 16 is located on the printing substrate carrier 11.

The list in the exemplary embodiment of FIG. 2 is not final, and it is not necessary for all the alternatives illustrated to be provided in the machine. For example, it is also possible to provide only one input device 14 with a connection 26 to the controllers 12, 12′, . . . , which call up the stored values based on experience 6, 6′, . . . for various printing substrate thicknesses 17. Alternatively, provision may be made for the influencing variables 4, 4′, . . . to be input directly at the input device 14 in the event of a printing-substrate change, or for the influencing variables 4, 4′, . . . to be taken from a memory 21 by the printing-machine controller 15. This can also be activated automatically or via an input at the input device 14. A further possibility, which is likewise possible separately, is to measure printing substrate thicknesses 17 by means of the described device 20, in order to call up stored influencing variables 4, 4′, . . . or data 6, 6′, . . . in order to calculate the latter.

However, it is most expedient to provide all the possibilities in the manner illustrated in one machine, in order to be able to select one or the other alternative on the basis of the data available or the critical influencing variables during the operation of the machine. However, the configurations are only exemplary; other methods of allocating influencing variables and processing said influencing variables are conceivable.

Parts List

| | |
|---|---|
| 1 | Multicolor printing machine |
| 2, 2′, . . . | Equipment for the digital production of color separations |
| 3, 3′, . . . | Color separations |
| 4, 4′, . . . | Influencing variables of various printing substrate |
| | thicknesses |
| 5,5′ | Printed pages |
| 5 | Preceding printed page |
| 5′ | Following printed page |
| 6, 6′ | Stored data for various printing substrate grades or |
| | thicknesses |
| 7, 7′, . . . | Register marks |
| 8, 8′, . . . | Printing units |
| 9, 9′, . . . | Image cylinder |
| 10, 10′, . . . | Image transfer cylinder |
| 11 | Printing substrate carrier |
| 12, 12′, . . . | Controller for achieving in-register prints (for example |
| | assigned to the printing units) |
| 13, 13′, . . . | Memories |
| 14 | Input device |
| 15 | Printing-machine controller |
| 16 | Printing substrates |
| 17 | Printing substrate thickness, for example, paper thickness |
| 18 | Register sensor |
| 19 | Position detecting element, for example, rotary encoder |
| 20 | Device for measuring printing substrate thicknesses |
| 21 | Memory with files from printed pages |
| 22 | Sensor for detecting printing substrates |
| 23 | Drive roller of the carrier for printing substrates |
| 24 | Curved attitude |
| 25 | Transport belt for feeding printing substrates to the |
| | multicolor printing machine |
| 26 | Connection between input device and controllers |
| 27 | Connection between input device and printing-machine |
| | controller |
| 27′ | Connection between printing-machine controller and |
| | controllers (assigned to the printing units) |
| 28 | Connection between device 20 and the controllers |
| | (assigned to the printing units) |
| 28′ | Connection between device 20 and printing-machine |
| | controller |
| 29 | Arrow: transport direction |
| 30 | Transfer of a color separation from the image cylinder to |
| | the image transfer cylinder |
| 31 | Transfer of a color separation from the image transfer |
| | cylinder to a printing substrate |
| 32 | Arrow: directions of rotation |

What is claimed is:

1. A method of setting register in a multicolor printing machine (1) having a number of items of equipment (2, 2′, . . . ) for the digital production of color separations (3, 3′, . . . ), the actions of setting up and combining the color separations (3, 3′, . . . ) being controlled when printing substrates (16) of a different grade are fed in, in order to correct the register setting, wherein when the printing substrate thickness (17) is changed because of a printing-substrate change, the influence of the printing substrate thickness (17) on the register is taken into account directly as the change is implemented, by means of existing influencing variables (4, 4′, . . . ).

2. The method as claimed in claim 1, wherein in the event of a register correction because of a change in the printing substrate thickness (17), the retroactive influence (4) of the printing substrate thickness (17) of the printed page (5) which has gone before but is still in the printing process on the register of the new printed page (5′) that is already in the printing process is taken into account.

3. The method as claimed in claim 2, wherein the influencing variables (4, 4′, . . . ) of the printing substrate thicknesses (17) are taken into account on the basis of stored data (6, 6′, . . . ).

4. The method as claimed in claim 3, wherein the thicknesses (17) of a new grade of printing substrates (16) are measured before the latter are fed to the printing process.

5. The method as claimed in one of claim 3, wherein a change in the printing substrate thicknesses (17) is detected on the basis of a manual input.

6. The method as claimed in one of claim 3, wherein the influencing variables (4, 4′, . . . ) of the printing substrate thicknesses (17) are taken into account on the basis of a stored file (21) from the printed pages (5, 5′, . . . ).

7. The method as claimed in one of claim 6, wherein the influencing variables (4, 4′, . . . ) of various printing substrate thicknesses (17) are available as a result of the storage of the data (6, 6′, . . . ) from various printing substrate grades.

8. The method as claimed in one of claim 7, wherein said method is used to correct a register control system which is based on the detection of register marks (7, 7′, . . . ) which are printed by the individual printing units (8, 8′, . . . ), this correction being made before a change in the printed page and printing substrate can have any influence on the register marks (7, 7′, . . . ).

9. The method as claimed in one of claim 8, wherein said method is used to correct a register control system which is based on the detection of the positions of the elements (9, 9′, . . . , 10, 10′, . . . ; 11) that carry the color separations and substrate, before a change in the printing substrate can have any influence on the register marks (7, 7′, . . . ).

10. The method as claimed in one of claim 9, wherein further influencing variables which have an influence on the register resulting from a printed-page change (5, 5, . . . ) are taken into account when setting the register.

11. Apparatus for implementing a method as claimed in claim 10 with a multicolor printing machine (1) having a number of items of equipment (2, 2′, . . . ) for the digital production of color separations (3, 3′, . . . ), at least one controller (12, 12′, . . . ) performing a register correction by controlling the actions of producing and combining the color separations (3, 3′, . . . ) when printing substrates (16) of a different grade are fed in, wherein the at least one controller (12, 12′, . . . ; 15) is designed in such a way that when the printing substrate thickness (17) is changed, the influence on the register of the printing substrate thickness (17) is taken into account directly as the change is implemented, by means of existing influencing variables (4, 4′. . . ).

12. The apparatus as claimed in claim 11, wherein the at least one controller (12, 12′, . . . ; 15) is designed in such a way that in the event of a register correction because of a change in the printing substrate thickness (17), the retroactive influence (4) of the printing substrate thickness (17) of the printed page (5) which has gone before but is still in the printing process on the register of the new printed page (5′) that is already in the printing process is taken into account.

13. The apparatus as claimed in claim 12, wherein it is equipped with at least one memory (13, 13′, . . . ), which contains stored values based on experience of influencing variables (4, 4′, . . . ) of various printing substrate thicknesses (17), the at least one controller (12, 12′, . . . ) controlling the actions of setting up and combining the color separations (3, 3′, . . . ) on the basis of these values based on experience.

14. The apparatus as claimed in claim 13, wherein it has a device (20) for measuring printing substrate thicknesses (17), and the action of taking the latter 10 into account is activated by the device (20).

15. The apparatus as claimed in one of claim 14, wherein it is equipped with an input device (14) via which the action of taking the printing substrate thickness (17) into account can be activated manually.

16. The apparatus as claimed in one of claim 15, wherein a printing-machine control system (15) and a memory with files (21) from printed pages are provided, the influencing variables (4, 4′, . . . ) of various printing substrate thicknesses (17) being taken into account on the basis of these files (21).

17. The apparatus as claimed in claim 16, wherein the at least one controller (12, 12′, . . . ; 15) contains the influencing variables (4, 4′, . . . ) of the various printing substrate thicknesses (17) by means of data (6, 6′, . . . ; 21) stored in memories (13, 13′, . . . ; 21) and relating to various printing substrate grades.

18. The apparatus as claimed in claim 17, wherein the at least one controller (12, 12′, . . . ) is designed in such a way that it controls the register by means of register marks (7, 7′, . . . ) which are printed by the individual printing units (8, 8′, . . . ) and detected by a register sensor (18), and takes the influencing variables (4, 4′, . . . ) of the printing substrate thicknesses (17) as correction factors into account, the correction being made before the change caused by the printed page can have any influence on the register marks (7, 7′, . . . ).

19. The apparatus as claimed in claim 18, wherein the at least one controller (12, 12′, . . . ) is designed in such a way that it controls the register by means of detecting the positions of the elements (9, 9′, . . . ; 10, 10′, . . . ; 11) that carry the color separations and substrate by means of position detecting elements (19), and takes the influencing variables (4, 4′, . . . ) of the printing substrate thicknesses (17) as correction factors into account before the printing-substrate changes can have any influence on the register marks (7, 7′, . . . ).

20. The apparatus as claimed in claim 19, wherein the at least one controller (12, 12′, . . . ) is designed in such a way that it takes into account further influencing variables which have an influence on the register resulting from a printed-page change (5, 5′, . . . ) when setting the register.
